(19) United States
(12) Patent Application Publication
(10) Pub. No.: US 2019/0344860 A1
(43) Pub. Date: Nov. 14, 2019

(54) METHOD FOR ASSEMBLING A TRANSPORT TANK IN A VESSEL AND A CORRESPONDING VESSEL

(71) Applicants: Koole Engineering B.V., Bergen (NL); Orca Engineering B.V., Enschede (NL)

(72) Inventors: Jacobus Koole, Bergen (NL); Martijn Pieter van Poppelen, Enschede (NL); Martin Jonathan Berends, Kollumerzwaag (NL)

(21) Appl. No.: 16/328,336

(22) PCT Filed: Aug. 28, 2017
(86) PCT No.: PCT/NL2017/050565

§ 371 Date: Feb. 26, 2019

(30) Foreign Application Priority Data
Aug. 30, 2016 (NL) 2017393

(51) Int. Cl. B63B 11/04; B63B 25/16

(52) U.S. Cl. CPC B63B 11/04; F17C 2270/0105; B63B 25/16

(57) ABSTRACT

A method for assembling a transport tank includes the steps of providing a hull with two decks extending substantially in a horizontal direction and being arranged at a distance from each other; arranging a transport tank in the hull with one end wall being arranged near one of the two decks, with another end wall being arranged near the other one of the two decks, and with a tank circumferential wall extending in between the two end walls; forming one or more chambers between the end walls and the corresponding deck; and applying or getting applied an underpressure to the one or more chambers for exerting a pulling force on the external side of the corresponding tank end wall for at least partly withstanding a pulling force on the internal side of the corresponding tank end wall in case of an underpressure in the transport tank.

### CROSS-REFERENCE TO RELATED APPLICATIONS

This application is the National Stage of International Application No. PCT/NL2017/050565, filed Aug. 28, 2017, which claims the benefit of Netherlands Application No. NL 2017393, filed Aug. 30, 2016, the contents of which is incorporated by reference herein.

### FIELD OF THE INVENTION

The invention relates to a method for assembling a transport tank in a vessel and to a vessel provided with such a transport tank.

### BACKGROUND OF THE INVENTION

Transport tanks in vessels are commonly known to transport liquid media, such as chemicals, oil, liquified gases and agricultural products. The vessels are commonly referred to as tankers.

Tankers may be equipped with rectangular transport tanks that are integral with the vessel, so-called parcel tankers. The transport tanks are part of the vessel's structure, in which the tank walls are formed by the vessel's hull, profiled cross bulkheads and longitudinal bulkheads placed therein, and the vessel's deck.

Alternatively, tankers may be provided with several cylindrical transport tanks placed in the vessel's hull. See, for example, U.S. Pat. No. 6,167,827 or DE9309433.

When filled the transport tanks are subject to an overpressure, i.e. a pressure above atmospheric pressure. However, during emptying of the transport tank, an underpressure, i.e. a pressure below atmospheric pressure, e.g. 35-75 mbar, may occur in the transport tanks as well. Hence, the tank walls need to be designed to be able to withstand both types of pressures and as a result thereof, the tank walls are provided with reinforcement elements which take a lot of space and which may interfere with other requirements to the transport tanks, for instance the ability to cope with thermal expansion.

EP-1.868.880 discloses a ship with liquid transport tanks placed inside its hull. Each tank comprises a bottom, a circumferential wall and a roof. The tank bottom is supported on a lower deck of the ship's hull in particular with interposition of an insulation layer. The tank roof is suspended to an upper deck of the ship's hull in particular with interposition of an insulation layer. The tank circumferential wall is suspended by its lower and upper ends by means of deformable deformation absorbers between the lower and upper deck. The deformation absorbers are designed so as to absorb deformations between the ship's hull and the tank circumferential wall at least in an axial direction of the tank. The deformation absorbers extend in the circumferential direction around substantially the entire circumference of the tank circumferential wall and preferably form part of the tank wall while being accommodated at the position of the transitions between the tank circumferential wall and the tank bottom respectively roof so as to form a continuous sealing connection between them.

However, when the transport tank is or has been emptied, and for some kind of reason an underpressure starts to occur inside the tank, then this may lead to undesired plastic deformations of particularly the bottom and/or roof of the tank. If for example the empty tank gets cleaned with hot water, then the tank after the cleaning has finished may quickly cool off, particularly when cold ballast water gets pumped into the tank which may start present water vapour to condense. When in this situation the tank is closed, this may quickly lead to an underpressure of 200-300 mbar to occur inside the tank. If for example the tank is used for transport of edible oils and greases, then it may be required to heat up the tank wall during emptying and cleaning in order to more easily be able to drain the tank empty and/or rinse of the oil and grease of the tank walls. Then also during a subsequent cooling of the tank, an underpressure may start to occur inside the tank. A thus occurring underpressure inside the tank exerts strong pulling forces onto the internal sides of the tank bottom and roof. In order to prevent the tank bottom and roof to collapse inwards into the tank because of those pulling forces, it has appeared necessary to reinforce them and/or to connect them via heavy steel supporting beams to the lower and upper deck of the ship's hull. The reinforcement elements and/or the beam connections however take a lot of space and interfere with other requirements to the transport tanks, for instance the ability to cope with thermal expansion and the ability to deal with weight load forces and acceleration forces during transport at heavy sea.

A similar underpressure situation inside the tank may also occur in other situations like for example when the tank is used for transport of chemical liquids. The tanks then need to remain closed during emptying such that dangerous vapours cannot escape. For this purpose the tank's inside during emptying gets connected to a so-called return pipe which is designed to fill the tank with a suitable gas during emptying of its chemical liquid. However, because of resistances in this return pipe, safety valves and the like, then also an underpressure may start to occur inside the tank. Again the occurrence of this underpressure makes it necessary to reinforce the tank bottom and roof and/or connect them via heavy steel supporting beams to the lower and upper deck of the ship's hull. And again those reinforcement elements and/or beam connections take a lot of space and interfere with other requirements for the tanks.

### SUMMARY OF THE INVENTION

It is therefore an object of the invention to provide an improved transport tank in a vessel which allows to withstand underpressures that may occur inside the tank but eliminates or at least minimizes one or more of the abovementioned problems.

This object is achieved by a method for assembling a transport tank in a vessel, comprising the following steps:
a. providing a hull defining a storage space delimited by two decks extending substantially in a horizontal direction and being arranged at a distance from each other in a vertical direction;
b. arranging a transport tank in the storage space of the hull with one tank end wall being arranged near one of the two decks to extend substantially parallel to said one of the two decks, with another tank end wall being arranged near the other one of the two decks to extend substantially parallel to said other one of the two decks, and with a tank circumferential wall extending substantially in between the two tank end walls; and
c. forming one or more chambers between at least one of the tank end walls and the corresponding deck.

With this each tank end wall has an internal side that faces the inside of the transport tank, and an external side that faces away therefrom. According to the inventive thought the method is characterized in that it further comprises the step:
d. applying or getting applied an underpressure in the one or more chambers for exerting a pulling force on the external side of the corresponding tank end wall for at least partly withstanding a pulling force on the internal side of the corresponding tank end wall in case of an underpressure in the transport tank.

Owing to the invention the one or more chambers now can be configured such that the pressure in the one or more chambers prevents the corresponding tank end wall from plastically deforming up to an underpressure or a load corresponding to an underpressure of at least 20 mbar in the transport tank.

An example of a load corresponding to an underpressure in the transport tank is the weight of the upper tank end wall urging the tank end wall to deflect inwards. This effect is similar to an underpressure in the transport tank in the absence of gravity. Hence, from now on, where in the specification the term underpressure is used, it also refers to a load corresponding to an underpressure unless explicitly stated otherwise. This does not apply to the appending claims. In the appending claims, the term underpressure does not refer to a load corresponding to an underpressure. In order to include such load in the appending claims, this should be clearly mentioned.

An advantage of the method according to the invention is that the underpressure on the external side of the corresponding tank end wall(s) of the transport tank is used to withstand the internal underpressure that may occur inside the tank thereby allowing to reduce the required reinforcements of the tank end wall compared to the prior art.

When extensive reinforcements of the tank end wall are no longer necessary, the tank end wall is easier and cheaper to produce and will occupy less space, so that the tank end wall can be positioned closer to the corresponding deck. It further provides more design freedom to take measures for the transport tank to cope with thermal expansion and deformation of the hull.

Owing to the invention the transport tank can now be safely emptied, without running a risk of occurring underpressure inside the tank being able to lead to undesired plastic deformations of the bottom and/or top tank end walls. The empty tank can now safely be heated or cleaned with hot water, and allowed to thereafter quickly cool off. Underpressures of 200-300 mbar may now occur inside the tank without this leading to possible damaging of the tank.

Possibly occurring underpressures inside the tank no longer make it necessary to reinforce the bottom and/or top tank end wall. Also they no longer make it necessary to connect the bottom and/or top tank end wall via heavy steel supporting beams to the lower and upper deck of the ship's hull. This in turn makes it easier to cope with thermal expansion of the tank and its ability to deal with weight load forces and acceleration forces during transport at heavy seas.

Advantageously it is now even possible to reduce heights of the one or more chambers to no more than 50 mm. Maintenance underneath the bottom tank end wall and/or above the top tank end wall is not necessary and no space is required for reinforcements of the bottom or top tank end wall.

The invention makes it particularly possible to use the tank for transport of edible oils, greases, or chemicals.

It is noted that KR 2015/0056920 discloses a support structure for a substantially rectangular LNG storage tank inside a ship's hull in which a plurality of buffer means are provided all around the tank in between the tank and the hull. The buffer means each comprises a controllable piston-cylinder of which the cylinder is fixedly connected to the hull. Piston rods are connected to the pistons. Each piston rod is equipped with a free spherical shaped outer end that in an operative position lies inside freely movable inside a recess that is provided in a wooden isolation part that is fixedly connected to one of the outside walls of the tank. Furthermore a pressure sensor is provided for sensing whether the tank is expanding or contracting because of temperature changes. If so, then all the pistons are actively controlled to either move away from either towards the tank such that the tank remains supported all around with substantially constant pushing support forces.

In contrast to the present invention however those known buffer means are only destined to exert pushing support forces onto the tank walls. Their primary goal here is to disengage deformations of the ship's hull from the tank. The buffer means are only destined to keep the pushing support forces within certain aimed limits even when the ship's hull is deforming strongly. The buffer means of KR 2015/0056920 are unable to deal with a situation in which an underpressure would start to occur inside the tank.

Furthermore it is noted that in KR 2015/0056920 the system with the large number of buffering means is expensive, vulnerable and prone to wear, leakages, sensor malfunctions, etc. to occur. They make it necessary to manufacture the entire tank stiff all around, including its bottom, circumferential wall and roof, in order to be able to have the heavy tank supported all around by the slender piston rods. The piston rods are unable to absorb sideways deformations of the tank, like expansions or contractions due to temperature changes. For this reason also the entire tank needs to be constructed stiff with thick walls and/or from a material that hardly expands or contracts, like for example Invar. This however makes the tank expensive to build. Another disadvantage with this known construction is that a lot of space is required all around the tank in order to be able to deal with deformations of the ship's hull, such that the tank can retain its rectangular shape. At least half a meter of space is needed all around the tank in order to be able to have maintenance personnel perform maintenance to the tank walls and buffer means. Yet another disadvantage is that the stiff tank is difficult to install inside the ship, particularly because of dimensional tolerances and because of the large number of piston rods that need to fall inside the recesses. Besides that it is noted that the piston-cylinders need to be hydraulically operated, because a pneumatic control would act too much as a spring. Finally it is noted that a control system for synchronizing and controlling all the various piston movements is very complex in the case of dynamic load changes and thus still might lead to damaging of the tank for example during transport at heavy seas.

In an embodiment according to the present invention, the one or more chambers are configured such that the underpressure in the one or more chambers prevents the corresponding tank end wall from plastically deforming up to an underpressure of at least 35 mbar, preferably at least 75 mbar, more preferably at least 100 mbar, and most preferably at least 200 mbar in the transport tank.

Instead of defining the underpressure in the transport tank as relative pressure compared to atmospheric pressure conditions outside the vessel, it is also possible—as an alternative—to define the underpressure as an absolute pressure, resulting in the one or more chambers being configured such that the pressure in the one or more chambers prevents the corresponding tank end wall from plastically deforming when the absolute pressure in the transport tank is in the range of 880-1030 mbar assuming atmospheric pressure may vary between 900-1050 mbar.

However, in the remaining specification, the pressures will be presented as relative pressures unless specifically stated otherwise.

Although an underpressure in the transport tank may imply that the underpressure should occur everywhere in the transport tank, it is explicitly stated here that an underpressure in the transport tank may also refer to a local underpressure in the transport tank that exerts a pulling force on at least a part of a tank end wall.

In an embodiment, the underpressure applied to the one or more chambers is an underpressure of at least 20 mbar, preferably at least 35 mbar, more preferably at least 75 mbar, even more preferably at least 100 mbar, and most preferably at least 200 mbar. Preferably, the underpressure in the one or more chambers is chosen larger than an expected maximum underpressure in the tank, so that elastic deformation of the corresponding tank end wall as a result of the underpressure in the tank is prevented.

When the underpressure is applied to the one or more chambers present between the upper deck and corresponding tank end wall, the underpressure is also able to carry at least a part of the weight of the tank end wall. Preferably, the underpressure in the one or more chambers is chosen to prevent elastic deformation of the tank end wall as a result of an expected maximum underpressure in the tank and as a result of the weight of the tank end wall.

Preventing or reducing the elastic deformation of a tank end wall may be beneficial from fatigue point of view.

In a preferred embodiment the one or more chambers are directly delimited by the external side of the corresponding tank end wall. The one or more chambers thus lie directly against the corresponding tank end wall. Thus the underpressure that is applied or gets applied inside the chambers is also directly present at the external side of the corresponding tank end wall and thus is able to at least partly withstand an underpressure that is applied or gets applied on the internal side of the corresponding tank end wall.

In particular at least 20%, more in particular at least 50%, and even more in particular at least 80%, of the surface of the corresponding tank end wall gets to directly delimit the one or more chambers. Or in other words, in particular at least 20%, more in particular at least 50%, and even more in particular at least 80%, of the surface of the corresponding tank end wall gets covered by the one or more chambers. Thus it has appeared that enough pulling force can be applied to the external side of the corresponding tank end wall in order to sufficiently withstand the pulling forces exerted there upon by means of for example an underpressure of 200 mbar starting to occur inside the transport tank.

In an embodiment, the underpressure is at least partly applied to the one or more chambers by a vacuum pump connected to the one or more chambers.

The vacuum pump may be permanently connected to the one or more chambers, so that for instance, the underpressure is only applied during circumstances in which an underpressure in the transport tank is expected, e.g. during emptying of the transport tank. In that case, the underpressure may be maintained by continuously driving the vacuum pump.

Alternatively, the vacuum pump is temporarily connected to the one or more chambers, so that the underpressure is applied by the vacuum pump and subsequently, after reaching the desired underpressure, the underpressure is maintained by closing off the one or more chambers allowing to disconnect the vacuum pump. Underpres sure is in that case constantly applied to the tank end wall.

To prevent a tank end wall from plastically deforming, an initial underpressure in the one or more chambers is not required per se as long as the required underpressure in the one or more chambers is present or gets generated as soon as an underpressure in the transport tank starts to occur, and at least before plastic deformation of the corresponding tank end wall occurs. Hence, it is possible to make use of Boyle's law in which the product of volume and pressure is constant. Therefore, in an embodiment, the one or more chambers are closed and the volume of the one or more chambers in combination with an initial pressure in the one or more chambers is such that elastic deformation of the tank end wall inwards into the transport tank causes the volume of the one or more chambers to increase which automatically may cause an underpressure in the one or more chambers to start occurring or to get increased which may help to prevent the tank end wall from plastically deforming. Hence, when the volume of the one or more chambers is sufficiently small, the initial pressure in the one or more chambers may be a relative slight underpressure or even be an overpressure. Such an initial overpressure in the one or more chambers may be advantageous when a liquid is present in the one or more chambers, e.g. for heating and/or cooling purposes, so that in case of leakage fluids from the transport tank do not enter the one or more chambers.

Instead of the underpressure to automatically get increased or generated in the one or more chambers by means of elastic deformation of the corresponding tank end wall that begins to take place as soon as an underpressure in the transport tank starts to occur, it is for example also possible to make use of a pressure sensor inside the transport tank, which sensor is designed to send a signal to a vacuum pump that is connected to the one or more chambers to start pumping as soon as an underpressure is detected inside the transport tank or as soon as a pressure inside the transport tank drops below a certain threshold value.

In an embodiment, when an underpressure or initial overpressure is applied to the one or more chambers, a vacuum detection unit may be provided to detect a leakage of the one or more chambers. The vacuum detection unit may comprise a sensor to measure the pressure inside the one or more chambers. When this pressure deviates too much from the desired pressure, the integrity of the one or more chambers or the seal thereof may be compromised, and an indication may be given to an operator or user that plastic deformation of the tank end wall can no longer be prevented.

In an embodiment, the one or more chambers are closed, wherein at least 90%, preferably at least 95%, and more preferably at least 98% of a gas inside the one or more chambers is inert, preferably nitrogen. This has the advantage that a leakage of the transport tank into the one or more chambers will not cause a reaction with the content of the transport tank and corrosion effects are diminished by the lack of oxygen in the chamber.

In an embodiment, the one or more chambers are provided with support elements between the tank end wall and the corresponding deck. Preferably, the support elements are connected to the corresponding deck, e.g. to support the corresponding tank end wall in case of an overpressure in the transport tank, which is usually the case when the transport tank is filled with medium.

In an embodiment, the one or more chambers are at least partially filled with insulation material to provide thermal insulation. Preferably, at least part of the insulation material forms at least a part of the support elements. In that case it is preferred that the insulation material is able to withstand a pressure of at least 1 bar, preferably at least 2 bar, more preferably at least 3 bar, most preferably at least 5 bar, not only to withstand the weight of the transport tank and its content, but preferably also to withstand acceleration forces and any overpressure in the transport tank and any underpressure in the chamber.

In an embodiment, the one or more chambers are provided only between a part of the tank end wall and the corresponding deck, for instance at the central part where the deformations are expected to be the largest or alternatively at the circumferential part of the tank end wall. Preferably, the one or more chambers are provided between the entire tank end wall and the corresponding deck.

In an embodiment, the circumferential wall of the transport tank is accessible via the storage space for personnel, e.g. maintenance personnel. Hence, in that case, the one or more chambers are only provided between tank end walls and the corresponding decks and not between the circumferential wall and the hull.

In order to close the one or more chambers, a sealing skirt may be arranged between the transport tank and the corresponding deck, e.g. between the tank end wall and the corresponding deck or alternatively between the circumferential wall and the corresponding deck. Preferably, the sealing skirt comprises two telescoping parts of which one is connected to the transport tank, e.g. the tank end wall or circumferential wall, whereas the other one is connected to the corresponding deck, wherein the telescoping parts are telescopingly slideable relative to each other in the vertical direction while substantially maintaining a gastight seal between them.

The sealing skirt may comprise an elastically deformable part, preferably a rubber band.

In an embodiment, the one or more chambers are closed off by an elastically deformable part between the transport tank and corresponding deck allowing the transport tank to deform and/or move relative to the vessel.

In an embodiment, the tank end wall has a thickness of less than 10 mm, and/or the tank end wall forms a flexible membrane, in particular one that in absence of the restoring forces applied by the one or more chambers and the pressure provided therein plastically deforms when an underpressure of 20 mbar is applied to the transport tank.

In an embodiment, the tank end wall has a flexibility in a direction perpendicular to its surface inwards into the tank that is larger than a flexibility of the tank circumferential wall in a direction perpendicular to its surface into the tank.

In an embodiment, the vessel further comprises deformation absorbers in the tank circumferential wall or between the circumferential wall and a tank end wall to absorb deformations of the hull in at least the vertical direction. In particular a transport tank with deformation absorbers is used in combination with the present invention as is shown and described in EP-1.868.880, which is enclosed by reference here, that is to say a liquid transport tank to be placed inside a ship's hull, of which the tank circumferential wall is suspended by its lower and upper ends by means of deformable deformation absorbers between the lower and upper deck, and wherein the deformation absorbers are designed so as to absorb deformations between the ship's hull and the tank circumferential wall at least in an axial direction of the tank, and wherein the deformation absorbers extend in the circumferential direction around substantially the entire circumference of the tank circumferential wall and preferably form part of the tank wall while being accommodated at positions of transitions between the tank circumferential wall and the bottom tank end wall respectively top tank end wall so as to form a continuous sealing connection between them.

Hence, the tank end walls can be embodied to be relatively flexible allowing to follow deformations of the hull of the vessel, while the circumferential wall can be embodied relatively stiff and does not have to deform as the deformation absorbers deform instead.

Preferably, the deformation absorbers are provided between the tank end wall and at least one of the two decks of the hull, respectively, to form a seal between the transport tank and at least one deck.

In an embodiment, at least one of the one or more chambers is provided with an overpressure and at least another one of the one or more chambers is provided with an underpressure to prevent plastic deformation in case of an underpressure in the transport tank.

In an embodiment, the applied underpressure to the one or more chambers is also used to restrain horizontal movement of the transport tank with respect to the corresponding deck.

In an embodiment, a heating or cooling system is provided to circulate heating or cooling medium through at least a part of the one or more chambers to heat or cool the transport tank.

In an embodiment, the lower tank end wall is sloped with a pump well at a lowest point in the tank end wall.

In an embodiment, the underpressure applied to the one or more chambers is an underpressure which results in deformation of the tank end wall towards support elements to obtain a concave shape of the tank end wall. Hence, the applied underpressure is simultaneously used to obtain a desired shape of the tank end wall.

In an embodiment, the tank circumferential wall has a cylindrical shape seen in plan view. Alternatively, the tank circumferential wall may have a substantially polygonal shape in plan view, wherein preferably the corners of the polygonal shape are rounded.

The invention also relates to a vessel comprising:
a hull defining a storage space delimited by two decks extending substantially in a horizontal direction and being arranged at a distance from each other in a vertical direction;
a transport tank in the storage space of the hull, the transport tank comprising:
   a tank end wall being arranged near one of the two decks to extend substantially parallel to said one of the two decks;
   another tank end wall being arranged near the other one of the two decks to extend substantially parallel to said other one of the two decks, each tank end wall having an internal and an external side; and
   a tank circumferential wall extending substantially in between the two tank end walls,
one or more chambers between at least one of the tank end walls and the corresponding deck.

According to a first aspect of the inventive thought the one or more chambers are provided with an underpressure for exerting a pulling force on the external side of the corresponding tank end wall for at least partly withstanding a pulling force on the internal side of the corresponding tank end wall in case of an underpressure in the transport tank. According to a second aspect of the inventive thought the one or more chambers are closed, wherein the corresponding tank end wall is elastically deformable for getting an underpressure at least partly applied in the one or more chambers by elastic deformation of the tank end wall inwards into the transport tank causing the volume of the one or more chambers to increase.

For both aspects the one or more chambers can be configured so as to prevent the corresponding tank end wall from plastically deforming up to an underpressure or a load corresponding to an underpressure of at least 20 mbar in the transport tank.

Features and/or embodiments described previously with respect to the method according to the invention can also be features and/or embodiments of the vessel according to the invention where applicable and will not be unduly repeated here.

### BRIEF DESCRIPTION OF THE DRAWINGS

The invention will now be described in a non-limiting way by reference to the accompanying drawings in which like parts are indicated by like reference symbols, and in which:

FIG. 1A depicts a cross section of a vessel according to an embodiment of the invention;

FIG. 1B depicts a detail of the cross section of FIG. 1A;

FIG. 2A-2J depict various embodiments of the bottom tank end wall and the one or more chambers in between the bottom tank end wall and the lower deck;

FIG. 3A shows a schematic view of a lower part of the tank of FIG. 1 with atmospheric pressure both inside the chamber as well as inside the tank, causing the bottom tank end wall to remain undeformed;

FIG. 3B shows the view of FIG. 3A with an underpressure that has started to occur inside the tank, that has caused the bottom tank end wall to get elastically deformed upwards until a substantially equal underpressure has started to occur inside the chamber;

FIG. 4A shows the view of FIG. 3A with atmospheric pressure inside the tank and with an initial underpressure inside the chamber, causing the bottom tank end wall to be drawn against an insulation layer;

FIG. 4B shows the view of FIG. 4A with an underpressure that has started to occur inside the tank, that has not caused the bottom tank end wall to get elastically deformed upwards because of the underpressure inside the chamber still being larger than the underpressure inside the tank;

FIG. 4C shows the view of FIG. 4B with the underpressure inside the tank having become larger than the initial underpressure inside the chamber, which has caused the bottom tank end wall to get elastically deformed upwards until a substantially equally larger underpressure has started to occur inside the chamber;

FIG. 5A shows a schematic view of an upper part of the tank of FIG. 1 in which a safety delimiter is provided in the chamber;

FIG. 5B shows the view of FIG. 5A when an initial underpressure in the chamber has fallen away;

FIG. 6 shows a schematic view of a lower part of the tank of FIG. 1 with a sealing skirt arranged between the circumferential tank wall and the lower deck;

FIG. 7 shows the view of FIG. 6 with the sealing skirt arranged between the bottom tank end wall and the lower deck; and

FIG. 8 shows the view of FIG. 6 with the sealing skirt forming a telescopic part with the circumferential tank wall.

### DETAILED DESCRIPTION OF THE INVENTION

The vessel 1 comprises a hull 3 in this embodiment with a lower deck 4, an upper deck 5 and side walls 6, 7 delimiting a storage space 8.

In the storage space 8, a transport tank 10 is arranged having a bottom tank end wall 11 arranged near the lower deck 4 and extending substantially parallel to the lower deck 4, a top tank end wall 12 arranged near the upper deck 5 and extending substantially parallel to the upper deck 5, and a tank circumferential wall 13 extending in between the bottom tank end wall 11 and top tank end wall 12 substantially perpendicular to both tank end walls 11, 12.

The tank circumferential wall 13 may be cylindrical or may have a substantially polygonal shape in plan view, wherein preferably the corners of the polygonal shape are rounded.

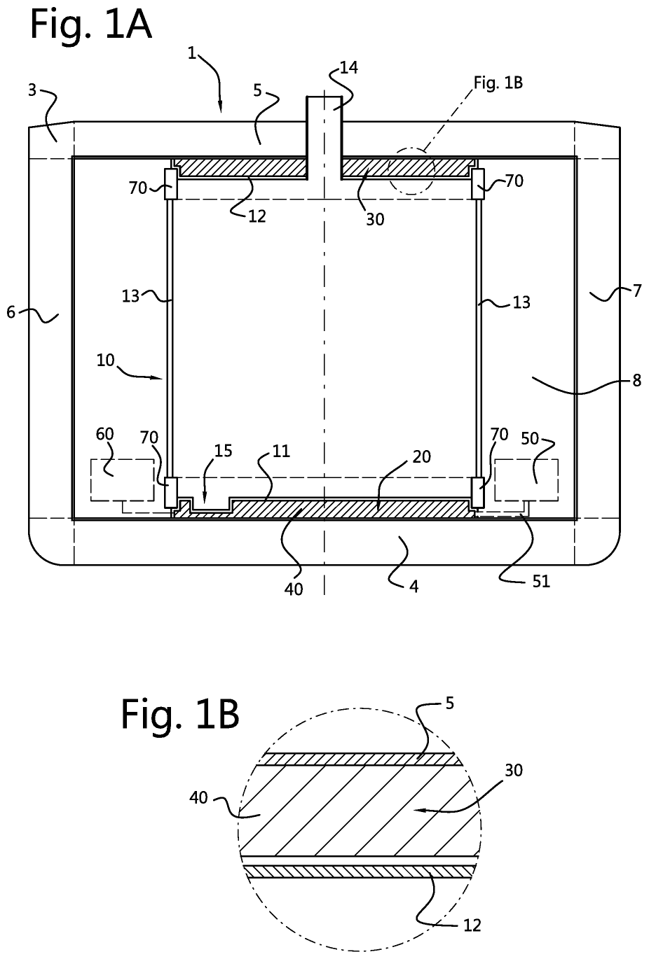

Although in FIG. 1A only one transport tank 10 is shown, it will be apparent that the vessel 1 may comprise a plurality of similar transport tanks 10.

To fill the transport tank 10, a fill port 14 may be provided in the top tank end wall 12, which fill port 14 preferably extends through the upper deck 5 allowing to fill the transport tank 10 from above the upper deck 5.

To empty the transport tank 10, a pump well 15 may be provided in the bottom tank end wall 11, wherein the pump well 15 preferably forms the lowest point of the bottom tank end wall so that all medium in the transport tank will flow towards the pump well 15 for an efficient emptying of the transport tank 10.

Between the bottom tank end wall 11 and the lower deck 4, a chamber 20 is provided, and between the top tank end wall 12 and the upper deck 5, a chamber 30 is provided. The circumferential wall 13 is free from the sidewalls 6 and 7, so that the transport tank is accessible using the space in between the sidewalls 6, 7 and the circumferential wall 13 and so that the sidewalls 6, 7 may deform without affecting the transport tank.

When emptying the transport tank, an underpressure may be applied to the interior of the transport tank 10. This underpressure can apply relatively large forces to the bottom tank end wall 11 and the top tank end wall 12 with plastic deformation as a result, which is undesirable.

Hence, according to the invention an underpressure is applied to the chambers 20 and 30, such that plastic deformation of the respective bottom tank end wall 11 and top tank end wall 12 can be prevented up to an underpressure of at least 20 mbar in the transport tank, preferably up to an underpressure of at least 35 mbar, more preferably up to an underpressure of at least 75 mbar, even more preferably up to an underpressure of at least 100 mbar, and most preferably up to an underpressure of at least 200 mbar.

Preventing plastic deformation using underpressure on the respective bottom tank end wall and top tank end wall can be achieved in various ways including but not limited to:
1) applying a permanent underpressure of at least 20 mbar, preferably of at least 35 mbar, more preferably of at least 75 mbar, even more preferably of at least 100 mbar, and most preferably of at least 200 mbar to the chambers 20 and 30;
2) temporarily applying an underpressure of at least 20 mbar, preferably of at least 35 mbar, more preferably of at least 75 mbar, even more preferably of at least 100 mbar, and most preferably of at least 200 mbar to the chambers 20 and 30, e.g. only in cases when an underpressure in the transport tank is expected;
3) applying an initial pressure to the chambers 20 and 30, and subsequently closing off the chambers, wherein the chambers 20 and 30 are dimensioned such that elastic deformation of the respective tank end walls 11, 12 inwards into the tank 10 causes a volume increase of the chambers 20, 30 leading to an underpressure in the chambers 20 and 30 of at least 20 mbar, preferably of at least 35 mbar, more preferably of at least 75 mbar, even more preferably of at least 100 mbar, and most preferably of at least 200 mbar.

In the embodiment of FIGS. 1A and 1B the chambers are filled with insulation material 40 providing thermal insulation, which is especially advantageous when the medium in the transport tank is held at a temperature different from the environment. The insulation material 40 is in this case also embodied to function as support element to support the bottom tank end wall 11 and top tank end wall 12 in case of an overpressure in the transport tank 10 urging the tank end walls 11, 12 outwardly. The tank end walls will then engage with the insulation material and prevent any further deformation.

FIG. 1A further discloses a vacuum pump 50 connected to the chamber 20 via tubing 51. The vacuum pump is able to apply an underpressure to chamber 20. The vacuum pump is depicted using dashed lines as in an embodiment, the vacuum pump is only temporarily present, namely once to apply the desired underpressure after which the chamber 20 is closed off to maintain this underpressure. The same vacuum pump 50, or another vacuum pump may also be connected to chamber 30.

However, the vacuum pump may also be provided more permanently, e.g. when maintaining the underpressure can only be achieved by continuously driving the vacuum pump. This may also apply to the situation that the underpressure is only applied temporarily, e.g. only in case an underpressure can occur in the transport tank, in particular during emptying and/or cleaning.

Especially when the chambers 20 and 30 are closed off, a vacuum detection system 60 may be provided allowing to monitor the pressure inside the chamber 20, and possibly also inside chamber 30, thereby allowing to monitor the risk of plastic deformation of the tank end wall and e.g. to indicate whether pressure is lost, for instance due to a leak.

The circumferential wall 13 comprises deformation absorbers 70 to absorb deformations of the hull 3 in at least the vertical direction.

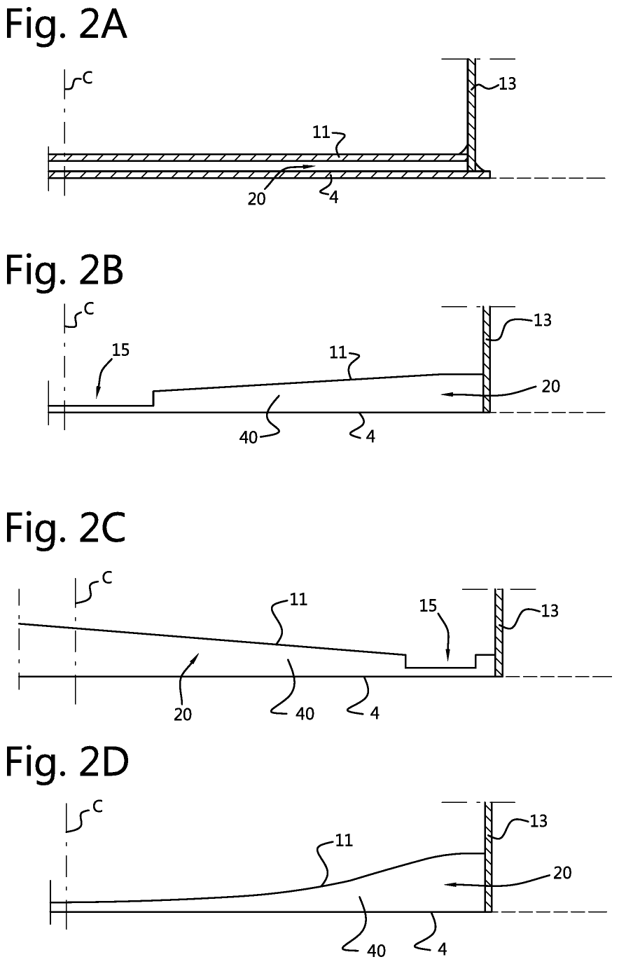

FIGS. 2A-2J depict various embodiments of the bottom tank end wall 11 and the one or more chambers 20 in between the bottom tank end wall 11 and the lower deck 4. The FIGS. 2A-2J only depict half of the cross section as the other half is symmetrical about a centre C or can easily be derived from the shown half.

Although FIGS. 2A-2J depict various embodiments in relation to the bottom tank end wall 11, the embodiments can also or alternatively be applied to the top tank end wall 12.

FIG. 2A depicts a variant in which there is a single chamber 20 between the bottom tank end wall 11 and the lower deck 4, which chamber is closed off as indicated in the detailed drawing on the right of FIG. 2A and has a relatively small volume. The small volume allows prevention of plastic deformation by creating sufficient underpressure due to elastic deformation of the bottom tank end wall caused by underpressure in the transport tank. The initial pressure in the chamber 20, i.e. the pressure in the chamber 20 in an undeformed state of the bottom tank end wall may then even be an overpressure or atmospheric pressure.

FIG. 2B depicts a variant in which there is a single chamber 20, which is partially filled with insulation material 40, which also acts as support element. The bottom tank end wall 11 is sloped towards the centre C of the bottom tank end wall 11 to end in a pump well 15.

FIG. 2C depicts a variant similar to the variant of FIG. 2B, but with the difference that the pump well 15 is now located near the circumferential wall 13 and the bottom tank end wall is sloped towards the pump well 15 which slope extends beyond the centre C of the transport tank.

FIG. 2D depicts a variant in which the bottom tank end wall 14 is curved with the closest distance to the lower deck 4 at the centre C of the bottom tank end wall 11. This variant may be assembled by providing the insulation material 40 in the desired shape, providing a flat bottom tank end wall 11 and apply an underpressure to the chamber 20 thereby pulling the bottom tank end wall 11 towards or even against the insulation material 40. Advantage of this assembly feature is that the bottom tank end wall is less susceptible for folding due to e.g. thermal compression stresses in the bottom tank end wall 11.

FIG. 2E depicts a variant in which there is a single chamber 20 which lower half is filled with insulation material 40 and which upper half comprises conduits 80 allowing to transport cooling or heating medium. The conduits 80 may also be integrally formed with the bottom tank end wall 11 thereby forming a channel plate.

FIG. 2F depicts a variant similar to the variant of FIG. 2E, but in which the bottom tank end wall is formed as a pillow plate forming channels 90 to transport cooling or heating medium.

FIG. 2G depicts a variant in which support elements 100 are provided to support the bottom tank end wall, especially in case of overpressure in the transport tank. In between the support elements 100, insulation material 40 is provided. The support elements 100 may divide the space below the bottom tank end wall into a plurality of chambers, but the support elements may also be provided in the form of blocks or cylindrical elements.

FIG. 2H depicts a variant in which insulation material 40 is stacked with tubing 110, preferably spirally shaped tubing 110. The tubing may be used for transporting heating or cooling medium, in which case the tubing may be rigid, but may alternatively be filled with gas to provide an air spring.

FIG. 2I depicts a variant similar to the variant of FIG. 2H as it includes the tubing 110, but lacks the insulation material 40. Further, the deformation absorbers are here provided in between the circumferential wall 13 and the lower deck 4, but may alternatively be also provided between the bottom tank end wall 11 and lower deck 4.

FIG. 2J depicts a variant in which a central portion of the bottom tank end wall is supported by insulation material 40 and the tubing 110 is provided at a circumferential portion of the bottom tank end wall 11.

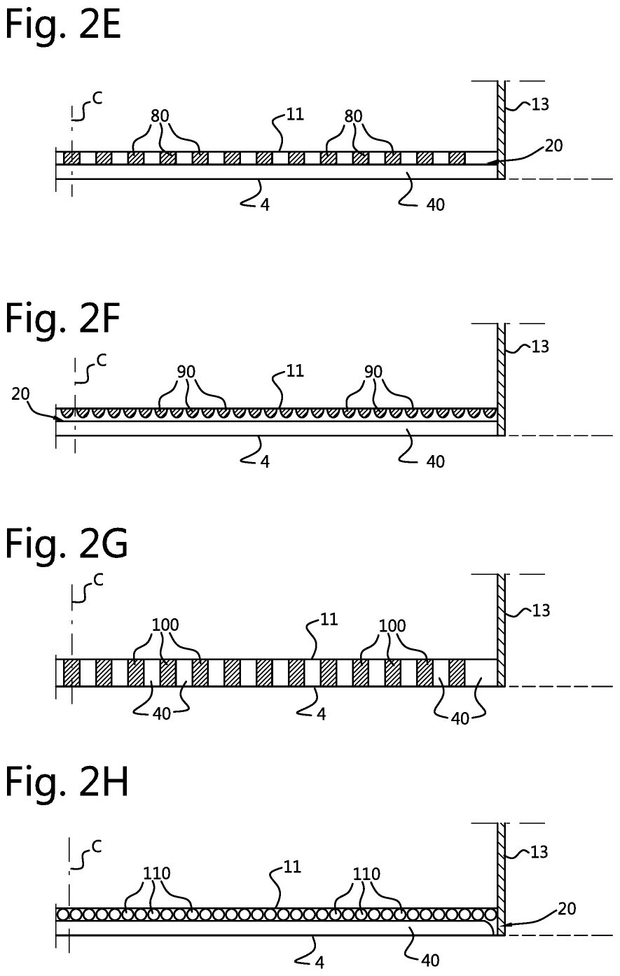

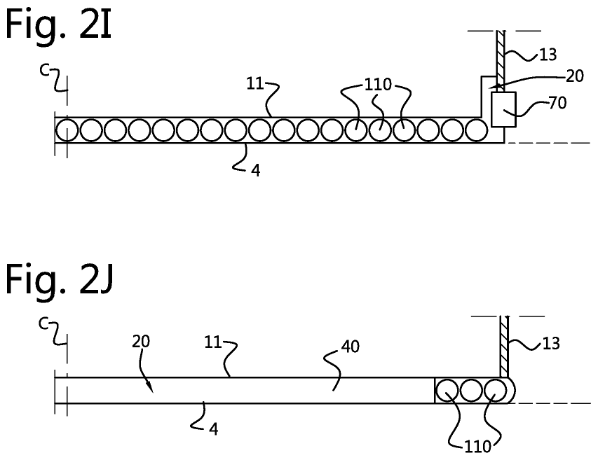

In FIGS. 3 and 4 some possible situations are shown that may occur with the tank 10 of FIG. 1 in dependency of initial pressures in the chamber 20 and in dependency of pressures that occur inside the tank 10.

In FIG. 3A a starting situation is shown in which the closed chamber 20 is applied with an initial atmospheric pressure, that is to say no underpressure and no overpressure, here referred to as Pc=Patm. The chamber 20 here has an initial volume Vi. The tank 10 here is empty and inside the tank 10 also an atmospheric pressure occurs, here referred to as Pt=Patm.

In FIG. 3B it is shown that an underpressure of 50 mbar, here referred to as Pt=Patm−50 mbar, has started to occur inside the tank 10. Because of this an upwards directed pulling force gets exerted by this underpressure Pt onto the internal upper side of the bottom tank end wall 11. This upwards directed pulling force onto the internal upper side of the bottom tank end wall 11 causes the bottom tank end wall 11 to elastically deform upwards. This increases the initial volume Vi of the chamber 20 with an extra volume Ve. This volume increase of the closed chamber 20, causes the initial pressure Pc inside the chamber 20 to drop, and stops as soon as a balanced situation is obtained again. In this balanced situation the underpressure Pc inside the chamber 20 has become substantially the same as the underpressure Pt inside the tank 10, that is to say Pc=Pt=Patm−50 mbar. With this it is noticed that the bottom tank end wall 11 itself also exerts a force to pull it back towards its undeformed starting position. The underpressure inside the chamber therefore is deemed to be slightly higher than the underpressure inside the tank in this situation.

In FIG. 4A a starting situation is shown in which the closed chamber 20 is applied with an initial underpressure of 75 mbar, here referred to as Pc=Patm−75 mbar. The chamber 20 here has an initial volume Vi. The tank 10 here is empty and inside the tank 10 an atmospheric pressure occurs, here referred to as Pt=Patm. In this situation a downwards directed pulling force gets exerted by the underpressure Pc onto the external lower side of the bottom tank end wall 11. This downwards directed pulling force onto the external lower side of the bottom tank end wall 11 causes the bottom tank end wall 11 to get pulled downwards against the insulation material 40.

In FIG. 4B it is shown that an underpressure Pt=Patm−50 mbar has started to occur inside the tank 10. However, since this underpressure Pt=Patm−50 mbar in the tank 10 is still less strong than the underpressure Pc=Patm−75 mbar in the chamber 20, the bottom tank end wall 11 shall remain being pulled against the insulation material 40.

In FIG. 4C it is shown that an underpressure Pt=Patm−100 mbar has started to occur inside the tank 10. Since this underpressure Pt=Patm−100 mbar in the tank 10 is stronger than the initial underpressure Pc=Patm−75 mbar in the chamber 20, the bottom tank end wall 11 shall no longer remain being pulled against the insulation material 40. Instead the upwards directed pulling force that gets exerted by the increased underpressure Pt onto the internal upper side of the bottom tank end wall 11, shall cause the bottom tank end wall 11 to elastically deform upwards. The corresponding volume increase of the closed chamber 20, then causes the initial pressure Pc inside the chamber 20 to drop, and become substantially the same as the underpressure Pt inside the tank 10, that is to say Pc=Pt=Patm−100 mbar. Here also it is noticed that the bottom tank end wall 11 itself also exerts a force to pull it back towards its undeformed starting position. The underpressure inside the chamber therefore is deemed to be slightly higher than the underpressure inside the tank in this situation.

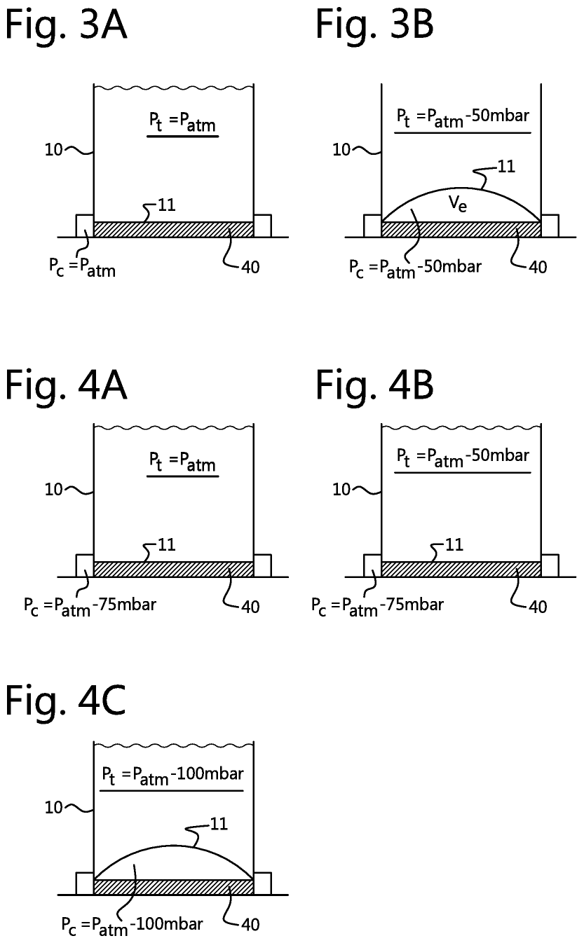

In FIG. 5A the chamber 30 of FIG. 1 that is present between the upper deck 5 and the top tank end wall 12 is shown with the insulation material 40 being provided therein. It can be seen here that hook-shaped safety delimiters 120, 121 are connected to the top tank end wall 12 and upper deck 5 respectively. Those delimiters 120, 121 are slidable relative to each other in the vertical axial direction over a maximum distance yl. In FIG. 5A a situation is shown in which an underpressure Pc has been applied in the chamber 30 that causes the top tank end wall 12 to be pulled against the insulation material 40 as long as this underpressure Pc leads to larger upwards pulling forces getting exerted onto the top tank end wall 12 than downwards directed pulling forces acting thereupon. Those downwards directed pulling forces then comprise the downwards directed weight load of the top tank end wall 12 if applicable added with downwards directed pulling forces caused by an underpressure Pt that may start to occur inside the tank 10.

In FIG. 5B the situation is shown in which the underpressure Pc in the chamber 30 has fallen away, for example because of the chamber 30 no longer being sealed properly or because of the vacuum pump 50 no longer functioning properly. In that situation the top tank end wall 12 no longer shall be pulled upwards against the insulation material 40 but shall elastically deform downwards at least under its own weight and possibly also because of an underpressure Pt occurring inside the tank 10. As a redundant safety measure the top tank end wall 12 then can be prevented from starting to plastically deform owing to the delimiters 120, 120 reaching their end positions in which they hook against each other.

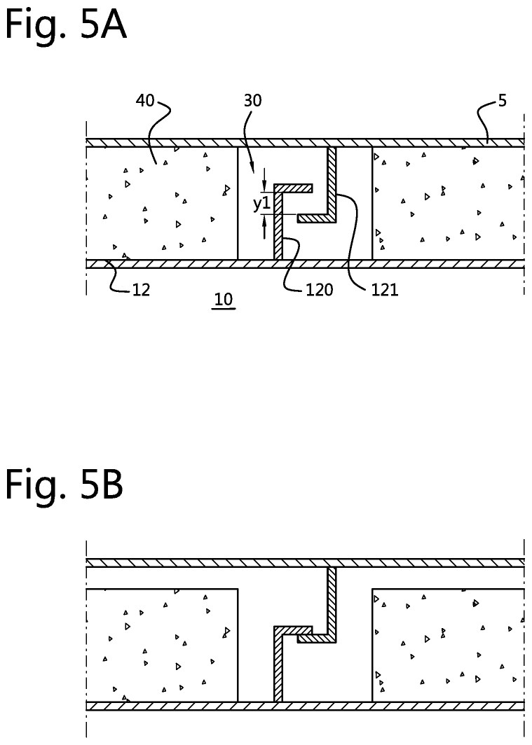

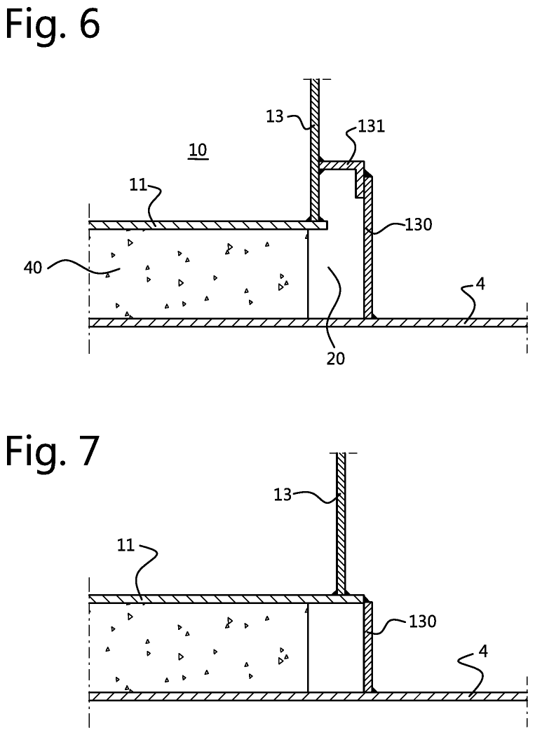

In FIG. 6 a variant is shown in which a sealing skirt 130 is fixedly arranged between the lower deck 4 and a connecting ring 131 that is welded to the circumferential tank wall 13. The sealing skirt 130 closes of the chamber 20 around its entire circumference. In the alternative the sealing skirt 130 may also be arranged between the bottom tank end wall 11 and the lower deck 4. This is shown in FIG. 7.

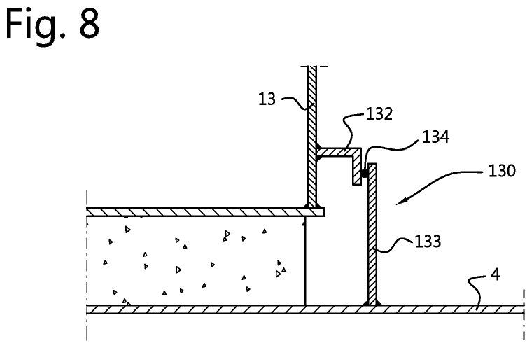

In FIG. 8 a variant is shown in which the sealing skirt 130 comprises two telescoping parts 132, 133 of which one is connected to the circumferential tank wall 13, whereas the other one is connected to the lower deck 4. The telescoping parts 132, 133 are telescopingly slideable relative to each other in the vertical direction while substantially maintaining a gastight seal between them. For this a sealing organ 134 is provided in between the two telescoping parts 132, 133.

Besides the embodiments shown numerous variants are possible. For example the shapes and dimensions of the various parts may differ. Also the initial pressures and/or underpressures applied to the chambers may differ.

Thus an environmental friendly vessel with transport tank is provided of which the transport tank can be easily and quickly assembled into the vessel in an economic manner and which transport tank then is optimally protected against situations in which an underpressure may start to occur inside the transport tank itself, in particular during emptying and/or cleaning.

1. A method for assembling a transport tank in a vessel, comprising the following steps:
providing a hull defining a storage space delimited by two decks extending substantially in a horizontal direction and being arranged at a distance from each other in a vertical direction;
arranging a transport tank in the storage space of the hull with one tank end wall being arranged near one of the two decks to extend substantially parallel to said one of the two decks, with another tank end wall being arranged near the other one of the two decks to extend substantially parallel to said other one of the two decks, and with a tank circumferential wall extending in between the two tank end walls, each tank end wall having an internal and an external side;
forming one or more chambers between at least one of the tank end walls and the corresponding deck; and
applying or getting applied an underpressure in the one or more chambers for exerting a pulling force on the external side of the corresponding tank end wall for at least partly withstanding a pulling force on the internal side of the corresponding tank end wall in case of an underpressure in the transport tank.

2. The method according to claim 1, wherein the underpressure in the one or more chambers is at least 20 mbar, in particular at least 35 mbar, more in particular at least 75 mbar, even more in particular at least 100 mbar, and most particular at least 200 mbar.

3. The method according to claim 1, wherein the one or more chambers are configured such that the underpressure in the one or more chambers at least prevents the corresponding tank end wall from plastically deforming inwards into the transport tank up to an underpressure or a load corresponding to an underpressure of at least 20 mbar in the transport tank.

4. The method according to one claim 1, wherein the underpressure is at least partly applied in the one or more chambers by a vacuum pump connected to the one or more chambers.

5. The method according to claim 4, wherein the underpressure in the one or more chambers is maintained by continuously driving the vacuum pump.

6. The method according to claim 4, wherein the underpressure in the one or more chambers is maintained by closing off the one or more chambers upon reaching the underpressure with the vacuum pump.

7. The method according to one claim 1, wherein the one or more chambers are closed, and wherein the underpressure in the one or more chambers at least partly gets applied by elastic deformation of the corresponding tank end wall inwards into the transport tank causing the volume of the one or more chambers to increase.

8. The method according to claim 1, wherein the one or more chambers are closed and at least partially filled with a gas, and wherein at least 98% of the gas inside the one or more chambers is inert, preferably nitrogen.

9. The method according to claim 1, wherein the one or more chambers are provided with support elements between the tank end wall and the corresponding deck to support the tank end wall.

10. The method according to claim 1, wherein the one or more chambers are at least partially filled with insulation material.

11. The method according to claim 10, wherein at least part of the insulation material forms at least a part of the support elements.

12. A vessel comprising:
a hull defining a storage space delimited by two decks extending substantially in a horizontal direction and being arranged at a distance from each other in a vertical direction;
a transport tank in the storage space of the hull, the transport tank comprising:
a tank end wall being arranged near one of the two decks to extend substantially parallel to said one of the two decks;
another tank end wall being arranged near the other one of the two decks to extend substantially parallel to said other one of the two decks, each tank end wall having an internal and an external side,
a tank circumferential wall extending in between the two tank end walls; and
one or more chambers between at least one of the tank end walls and the corresponding deck,
wherein the one or more chambers are provided with an underpressure for exerting a pulling force on the external side of the corresponding tank end wall for at least partly withstanding a pulling force on the internal side of the corresponding tank end wall in case of an underpressure in the transport tank, and/or
wherein the one or more chambers are closed, wherein the corresponding tank end wall is elastically deformable for getting an underpressure at least partly applied in the one or more chambers by elastic deformation of the tank end wall inwards into the transport tank causing the volume of the one or more chambers to increase.

13. The vessel according to claim 12, wherein the one or more chambers are configured so as to prevent the corresponding tank end wall from plastically deforming inwards into the transport tank up to an underpressure or a load corresponding to an underpressure of at least 20 mbar in the transport tank.

14. The vessel according to claim 12, wherein the external side of the corresponding tank end wall at least partly faces the inside of the one or more chambers, and wherein in particular at least 20% of the corresponding tank end wall is facing the inside of the one or more chambers, and wherein more in particular at least 50% of the corresponding tank end wall is facing the inside of the one or more chambers, and wherein even more in particular at least 80% of the corresponding tank end wall is facing the inside of the one or more chambers.

15. The vessel according to claim 12, wherein a vacuum pump is provided that is connected to the one or more chambers for at least partly applying the underpressure in the one or more chambers.

16. The vessel according to claim 12, wherein the one or more chambers are closed and at least partially filled with a gas, and wherein at least 98% of the gas inside the one or more chambers is inert, preferably nitrogen.

17. The vessel according to claim 12, wherein the one or more chambers are provided with support elements between the tank end wall and the corresponding deck to support the tank end wall.

18. The vessel according to claim 12, wherein the one or more chambers are at least partially filled with insulation material.

19. The vessel according to claim 18, wherein at least part of the insulation material forms at least a part of the support elements.

20. The vessel according to claim 12, wherein the one or more chambers are provided at least at a circumferential part of the corresponding tank end wall.

21. The vessel according to claim 12, wherein the one or more chambers are provided at substantially the entire corresponding tank end wall.

22. The vessel according to claim 12, wherein a sealing skirt is arranged between the transport tank and the corresponding deck, in particular wherein the sealing skirt comprises an elastically deformable part and/or telescoping parts.

23. The vessel according to claim 12, wherein the corresponding tank end wall has a thickness of less than 10 mm, and/or wherein the corresponding tank end wall forms a flexible membrane.

24. The vessel according to claim 12, further comprising deformation absorbers in the tank circumferential wall or between the transport tank and the hull to absorb deformations of the hull in at least the vertical direction.

25. The vessel according to claim 24, wherein the deformation absorbers are provided between the tank circumferential wall and the two decks of the hull, respectively, to form a seal between the transport tank and the two decks of the hull, respectively.
